(19) United States
(12) Patent Application Publication
(10) Pub. No.: US 2024/0037404 A1
(43) Pub. Date: Feb. 1, 2024

(54) Tensor Decomposition Rank Exploration for Neural Network Compression

(71) Applicant: Deeplite Inc., Montreal (CA)

(72) Inventors: Olivier MASTROPIETRO, Montreal (CA); Ehsan SABOORI, Richmond Hill (CA)

(73) Assignee: Deeplite Inc., Montreal (CA)

(21) Appl. No.: 18/358,331

(22) Filed: Jul. 25, 2023

Related U.S. Application Data
(60) Provisional application No. 63/369,437, filed on Jul. 26, 2022.

(51) Int. Cl. G06N 3/082; G06N 3/0495

(52) U.S. Cl. CPC G06N 3/082; G06N 3/0495

(57) ABSTRACT

A system, device and method are provided for reducing machine learning models for target hardware. Illustratively, the method includes providing a model, a set of training data, and a training threshold. A search space for reducing the model is determined with a pruning function and a pruning factor. The pruning function is bounded with constraints. Based on the constraints, boundaries for the pruning factor are determined, which boundaries define at least in part the search space. The pruning function increases compression along a depth of the model, and the compression increases are based on the pruning factor. A model is trained into a reduced model by iteratively updating model parameters based on the pruning function and the pruning factor and within the search space, and evaluating the updated model with the training parameters. The method includes providing the reduced model to target hardware.

### CROSS-REFERENCE TO RELATED APPLICATION(S)

This application claims priority to U.S. Provisional Patent Application No. 63/369,437 filed on Jul. 26, 2022, the contents of which are incorporated herein by reference in their entirety.

### TECHNICAL FIELD

The following generally relates to deep neural network (DNN) compression, and in particular to fast tensor decomposition ranks exploration for such compression, through the lens of structured pruning.

### BACKGROUND

The large size and slow computation of deep learning models can hamper their deployment in real-world applications, such as machine vision on embedded devices. Compressing these models is challenging in practice because of hardware particularities, for example, the inability of current GPU technology to handle sparse computation.

### SUMMARY

Tensor decomposition and structured pruning are two methods aimed at reducing the total tensor size and thus doing compression of deep neural networks irrelevant of the hardware being used. The following describes a method to explore a tensor decomposition's ranks through the lens of structured pruning that achieves state-of-the-art model size reduction while preserving performance on popular computer vision classification and object detection benchmarks.

In one example embodiment, the disclosed illustrative method is used to generate reduced deep neural networks for implementation on target hardware. The target hardware operating characteristics are determined (e.g., CPU or GPU capacity, memory, etc.). The operating characteristics are used to determine training threshold(s). The training threshold can be based on, for example, latency, where the target hardware is a camera used to identify intruders. In another example, the target thresholds can be based on latency to ensure rapid shutdown of factory equipment in the event that objects are detected in a working area of a potentially dangerous machine. Different thresholds can be used depending on the target application and the target hardware. For example, classification systems can emphasize accuracy over speed if being used for data collection or analysis, whereas object detection can emphasize speed for the reasons stated above.

In at least some example embodiments, the target hardware can be used for an application unrelated to an imaging device, or unrelated to a factory-based application. For example, the target hardware can be used to track inventory in a store based on aggregated barcode scans. In another example, the imaging device can be used in the context of a stadium, where illegal entry is identified.

These and other applications will be apparent to the person skilled in the art based on the disclosure herein.

In one aspect, there is provided a computer-implemented method. The method includes providing a model, a set of training data, and a training threshold. The method includes determining a search space for reducing the model with a pruning function and a pruning factor, wherein the pruning function increases compression along a depth of the model, and the compression increases are based on the pruning factor. The determining is performed by bounding the pruning function with two or more constraints, and determining, based on the two or more constraints, boundaries for the pruning factor. The determined boundaries at least in part define the search space. The method includes training the model to learn a reduced model by iteratively updating model parameters based on the pruning function and the pruning factor and within the search space, and evaluating the updated model based on the set of training data and the training threshold. The method includes providing the reduced model to a target hardware. Providing the model to the target model can include wireless transmission, wired transmission (e.g., by docking the target hardware to a larger computer system), physical transmission (e.g., via a USB), etc.

In example embodiments, the method further includes determining a granularity of the search spaced based on a number of searching steps.

The granularity |G| can be defined as S=log 2(|G|), where ‘s’ is the number of search steps.

In example embodiments, the training threshold is a target accuracy.

In example embodiments, the pruning function is a linear or exponential function.

In example embodiments, a pruning ratio for an individual layer r(i,g) of the updated model is defined by r(i,g)=max(min(g·r\hat{ }(i),rmax),rmin), wherein the pruning factor is g, the pruning function outputs r\hat{ }(i), and remaining terms are constraints.

The pruning ratio for the individual layer r(i,g) can be used to adjust a dimension of a decomposed tensor matrix that represents at least some of the updated model. The decomposed tensor matrix can receive input that corresponds to the adjusted dimension. The decomposed tensor matrix can output information corresponding to the adjusted dimension.

In example embodiments, the method further includes employing knowledge distillation to train the model for the target hardware for classification tasks.

In another aspect, there is provided a computer readable medium storing computer executable instructions for performing the disclosed method.

In another aspect, there is provided a hardware device comprising a processor and memory. The memory stores computer executable instructions for utilizing an optimized model generated according to the disclosed method.

### BRIEF DESCRIPTION OF THE DRAWINGS

Embodiments will now be described with reference to the appended drawings wherein:

FIG. 1 is an overview of combining tensor factorization and structured pruning.

FIG. 2 is a flow chart illustrating the proposed method.

### DETAILED DESCRIPTION

Over the last decade, deep learning (DL) has become the preferred method for machine learning solutions. DL algorithms and their foundational models have shown state-of-the-art performance, even surpassing human level accuracy in multiple applications across different domains. However, the penetration of DL solutions can be limited by multiple logistical challenges in consuming them. Models are typically large in size, computationally expensive, and often require specialized hardware and/or a graphics processing unit (GPU) to infer them with close to real-time latency. While a one-time model training could be performed in the cloud with extensive computational capabilities, the inference should be performed on much less expensive edge devices (alternatively referred to as target hardware), with limited memory and computational budgets.

There is a need for a paradigm shift from cloud computing towards edge computing for DL model inference.

Post training compression of DL models is a common approach to make them much smaller, faster, and computationally inexpensive. There are broadly four approaches for post training compression.

Decomposition/Factorization is used to find a low-rank approximation of a weight tensor, to break down a large convolution operation into multiple smaller ones.

Unstructured pruning is used to make the weight tensors as sparse as possible, by substituting them with zeros.

Structured pruning is used to reduce the number of channels per layer, resulting in a thinner model, with same number of layers.

For low precision quantization, while the parameters of the model are represented using floating point 32 bit precision (FP32), the aim of quantization is to have a low precision representation (FP16, INT8, INT4) for the parameters.

Unstructured pruning does not result in actual compression of the model and requires special runtime/HW and custom operations to execute the compressed models efficiently. Similarly, quantization is hardware-dependent and requires custom runtime for execution. These challenges reduce the practicality of unstructured pruning and quantization in industry applications for commodity hardware. However, factorization and structured pruning are hardware agnostic and can work for general-purpose compression applications.

Factorization results in a much smaller model with a higher chance of retaining the accuracy of the original model. On the other hand, structured pruning makes the model thin and faster, due to fewer number of channels per class. Most of the existing techniques either try to make the model smaller using factorization or use structured pruning to make the model faster. One can refer to surveys (Ji et al. 2019) for tensor decomposition and (Hoefler et al. 2021) on sparsity as both fields have large amount of work in the literature.

The following system .device and/or method proposes a process that views tensor factorization and structured pruning under a unified search problem in order to achieve very large compression levels while also respecting a constraint on model's performance drop and keeping the execution time within a reasonable amount.

### Constrained DNN Compression

Tensor Decomposition

Without loss of generality, consider the singular value decomposition of one single linear neural network layer with its parameter matrix M of dimension (d×d′):

M=UΣV^{T} (1).

Following (Zhang et al. 2015), the decomposition can be written with only two matrices by absorbing E to yield M=PQ where P=UΣ^{1/2} and Q=VΣ^{1/2}. One can then write

M=[P_{,j}mⱼ]Q (2),

where P is a (d×m) matrix, Q is (r×d′) and m is a vector of m ones with its j-th value being multiplied to the whole j-th column of P. There is vast literature on how to find the best m to preserve the original matrix's computation M (usually stated in terms of mean square error). One can view this as the classical low rank approximation problem in linear algebra because any scheme finding where to put zeroes in m can be taught of the indexes where to truncate the singular value decomposition.

Structured Pruning

The truncation does perform model compression because it reduces the dimensionality of P and Q. Since columns are being zeroed out, the resulting size of the matrix becomes (d×m)+(m×d′)<(d×d′) as m gets smaller. This is akin to the problem of finding the correct pruning ratios for doing structured pruning on matrix P.

There are two advantageous properties of this view. First, it brings the solution closer to DL model compression as the solution is not so interested in minimizing one single tensor's approximation compared to the general performance of the model as a whole (e.g., classification error). Second, the engineering behind this special type of pruning allows for high chances for successful implementation. Because it is all contained in r one only needs to adjust the output dimension of P and the input dimension of Q. There is no dependency graph to compute, or side-effects to consider (e.g., pruning a layer from a skip connection in a ResNet model).

The main drawback of sparsity is that when applied in a non-negligible fashion (in other words when one wants to obtain massive compression) it generally requires re-training the neural network. Therefore, any pruning method that wants to satisfy a specific drop in a model's performance can become very costly if it needs to be repeated multiple times.

It may be noted that unifying both problems under one umbrella is known (Li et al. 2020). However, it has been found that this view can be exploited with a novel heuristic.

Proposed Method

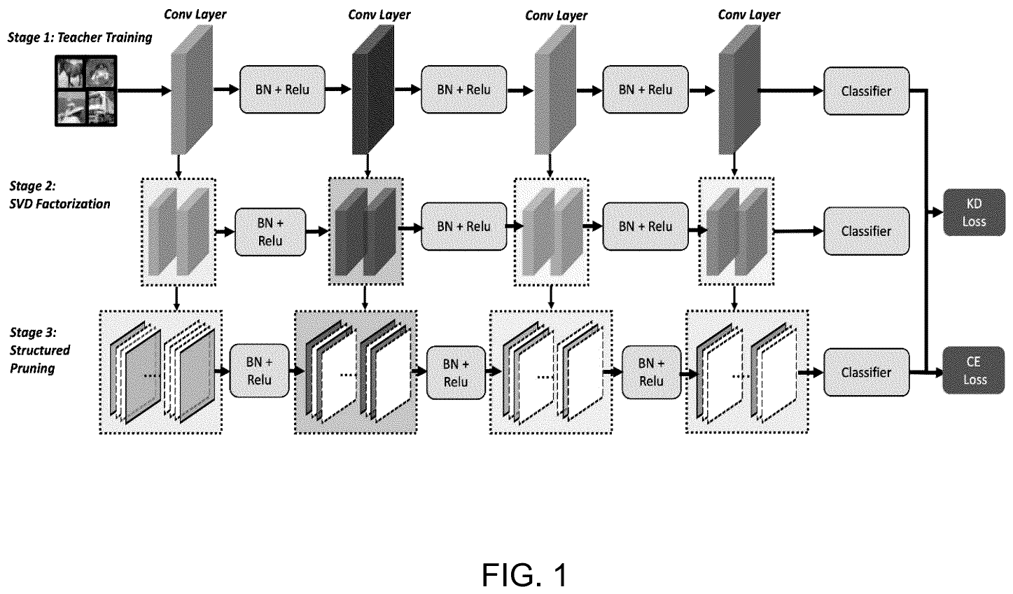

It is generally known in the realm of DL compression that one can compress layers more as one goes deeper in the model (see Lee et al. 2021 for an illustration of this experimental phenomenon). Using this observation as the only knowledge of each layer's specific sensitivity to pruning (measured in terms of global model's performance), one can begin with a simple function that computes a pruning ratio linearly increasing with depth.

$$\hat{r} ( i ) = \frac{i}{N - 1} ( {r}_{N - 1} - {r}_{0} ) + {r}_{0} , \qquad ( 3 )$$

where i is layer index in depth from 0 to N−1, r₀ is the ratio on the first layer, r_{N-1} on the last and 0≤r₀≤rᵢ≤r_{N-1}≤1. Both endpoints' pruning ratio values can be set as hyper-parameters, or, if one does have any prior knowledge on the layer's sensitivity, be derived. Or, one can use another function altogether (e.g., exponential). Finally, once every layer has its pruning ratio r one can use any available ratio based technique (random, L₂ norm, etc.) to compute the mask entries of m in equation (2). This process can be visualized by referring to FIG. 1.

The proposed algorithm is to search for a global scale on r\hat{ }(i) which is referred to herein as the growth of the curve. The new function for computing pruning ratios becomes:

r(i,g)=max(min(g·r\hat{ }(i),rₘₐₓ),rₘᵢₙ), (4)

where rₘₐₓ and rₘᵢₙ are maximum and minimum pruning ratios (naturally bounded by 1 and 0 respectively) and g is the control knob of the algorithm. In the original linear function proposal, the bigger g is, the more one can compress along depth, and the smaller it is, the less the model is compressible as a whole.

Furthermore, assuming this relationship between compressibility and the model's performance allows the system to cast the search as a binary search. Once the hyper-parameters of the algorithm r₀, r_{N-1}, rₘₐₓ and rₘᵢₙ are decided, one can solve for the boundaries r(i,gₘᵢₙ)=rₘᵢₙ and r(i,gₘₐₓ)=rₘₐₓ for all i. Having determined the range of g values, one can set the granularity of the search space |G| by choosing the number of search step S so that S=log₂(|G|).

Putting it all together, the search algorithm takes a pretrained model on some dataset, a constraint δ on performance drop (e.g., 1% accuracy) and the number of steps S and finds the requested solution only with S retraining. The remaining hyper-parameters of the algorithm need only to be tuned for the difficulty of the task. In practice only two different sets have been used depending on whether the task is classification or object detection.

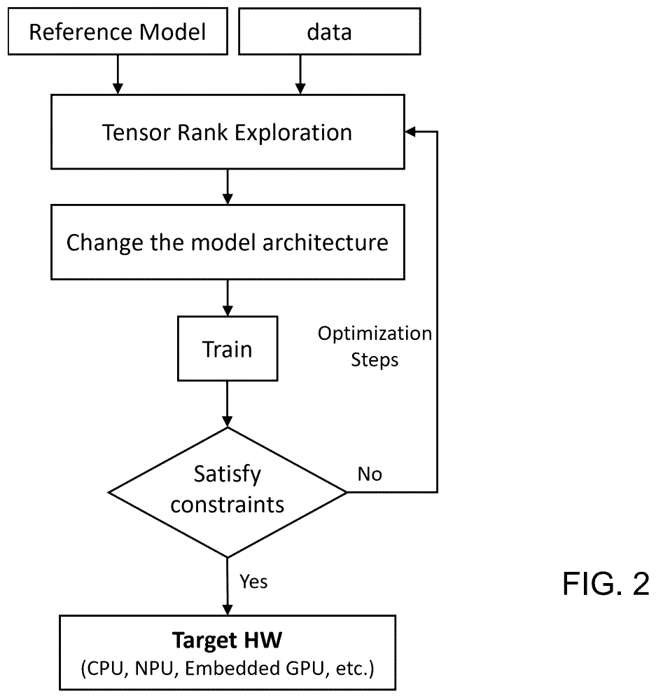

Referring to FIG. 2, the proposed solution is illustrated in summary. Beginning with a reference model and data, the tensor rank exploration described above is implemented in order to change the model architecture. The model architecture is changed after applying the tensor decomposition as detailed above, which can include replacing a large tensor with a smaller tensor with smaller rank (i.e., size). With the model architecture changed, the model can be trained. Once trained, the system determines if the model satisfies certain constraints, which can be defined as needed, e.g., in this example the delta (accuracy drop). If not, the tensor rank exploration step can be repeated to per the optimization steps. Once the constraints are satisfied, the trained model is provided to the target hardware, which can be any CPU, NPU, embedded GPU, etc., which executes an application that uses the trained model.

### Results

The search was executed on multiple datasets and models in order to validate its robustness to different scenarios (pre-trained models and datasets publicly available at https://github.com/Deeplite/deeplite-torch-zoo). The results are provided below in Table 1.

TABLE 1
Compression results using the proposed solution (performance
is accurate for CIFAR100/VWW and mAP for VOC)

| Source | | Pre-Trained | | Compressed | | | |
|---|---|---|---|---|---|---|---|
| Dataset | Model | Performance (%) | Size (mB) | Performance (%) | | Size (mB) | |
| CIFAR100 | VGG-19 | 72.38 | 42.80 | 71.63 | (−0.75) | 1.94 | (39.49x) |
| | Resnet18 | 76.83 | 42.80 | 75.83 | (−1.00) | 3.18 | (13.47x) |
| | Mobilenetv2 | 73.08 | 9.20 | 72.17 | (−0.91) | 3.10 | (2.97x) |
| VWW | Resnet18 | 93.55 | 42.64 | 92.64 | (−0.91) | 1.77 | (24.13x) |
| | Mobilenetv1 | 92.44 | 12.24 | 91.45 | (−0.99) | 0.73 | (16.75x) |
| VOC | Yolov5m | 87.4 | 79.91 | 85.4 | (−2.0) | 38.82 | (2.06x) |
| | Yolov5n | 73.5 | 6.83 | 71.5 | (−2.0) | 4.52 | (1.51x) |

All searches were done with S=5, the linear function formulation specified in equation 3 and the j-th where mⱼ=0 with L₂ norm. For classification, the process used δ=1, r₀=0.2, r_{N-1}=0.8, rₘᵢₙ=0.05 and rₘₐₓ=0.98 and for object detection, δ=2, r₀=0.25, r_{N-1}=0.75, rₘᵢₙ=0.2 and rₘₐₓ=0.8. It may be noted that the learning hyper-parameters were unchanged from how the pre-trained models were trained themselves. Knowledge distillation (Hinton et al. 2015) was used in order to boost results for classification tasks.

As one can see in the table, the search found very high compression ratios, as indicated in the number (1×) on the compressed size column, relative to the requested δ performance constraint. The execution times of all experiments are reported in Table 2 below.

TABLE 2
Execution times of the searches (format is in hh:mm:ss)

| Dataset | Model | Execution time |
|---|---|---|
| CIFAR100 | VGG-19 | 1:02:20 |
| | Resnet18 | 1:58:21 |
| | Mobilenetv2 | 5:20:42 |
| VWW | Resnet18 | 12:21:20 |
| | Mobilenetv1 | 16:33:41 |
| VOC | Yolov5m | 20:11:31 |
| | Yolov5n | 17:44:30 |

Classification results were computed on the same machine on a single Nvidia TitanV GPU. Object detection results were also computed on the same machine but on two Nvidia RTX A6000 GPU.

The above therefore demonstrates how to perform extreme levels of deep neural networks compression using a novel heuristic while respecting constraints on performance drop and execution time. The proposed search algorithm requires few hyperparameters and lower effort implementation.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the system, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

### REFERENCES

Hinton, G.; Vinyals, O.; Dean, J.; et al. 2015. Distilling the knowledge in a neural network. arXiv preprint arXiv:1503.02531.
Hoefler, T.; Alistarh, D.; Ben-Nun, T.; Dryden, N.; and Peste, A. 2021. Sparsity in Deep Learning: Pruning and growth for efficient inference and training in neural networks. CoRR, abs/2102.00554.
Ji, Y.; Wang, Q.; Li, X.; and Liu, J. 2019. A Survey on Tensor Techniques and Applications in Machine Learning. IEEE Access, PP: 1-1.
Lee, J.; Park, S.; Mo, S.; Ahn, S.; and Shin, J. 2021. Layer-adaptive Sparsity for the Magnitude-based Pruning. In International Conference on Learning Representations.
Li, Y.; Gu, S.; Mayer, C.; Gool, L. V.; and Timofte, R. 2020. Group Sparsity: The Hinge Between Filter Pruning and Decomposition for Network Compression. In Proceedings of the IEEE/CVF Conference on Computer Vision and Pattern Recognition (CVPR).
Zhang, X.; Zou, J.; Ming, X.; He, K.; and Sun, J. 2015. Efficient and accurate approximations of nonlinear convolutional networks. In IEEE Conference on Computer Vision and Pattern Recognition, CVPR 2015, Boston, MA, USA, Jun. 7-12, 2015, 1984-1992. IEEE Computer Society.

1. A computer-implemented method for reducing machine learning models for target hardware, the method comprising:
providing a model, a set of training data, and a training threshold;
determining a search space for reducing the model with a pruning function and a pruning factor, wherein the pruning function increases compression along a depth of the model, and the compression increases are based on the pruning factor, by:
bounding the pruning function with two or more constraints;
determining, based on the two or more constraints, boundaries for the pruning factor, the determined boundaries defining at least in part the search space;
training the model to learn a reduced model by iteratively:
updating model parameters based on the pruning function and the pruning factor and within the search space;
evaluating the updated model based on the set of training data and the training threshold; and
providing the reduced model to a target hardware.

2. The method of claim 1, the method comprising determining a granularity of the search spaced based on a number of searching steps.

3. The method of claim 2, wherein the granularity |G| is defined as:
S=log 2(|G|).
where ‘s’ is the number of search steps.

4. The method of claim 1, wherein the training threshold is a target accuracy.

5. The method of claim 1, wherein the pruning function is a linear or exponential function.

6. The method of claim 1, wherein a pruning ratio for an individual layer r(i,g) of the updated model is defined by:
r(i,g)=max(min(g·r\hat{ }(i),r max),r min)
wherein the pruning factor is g, the pruning function outputs r\hat{ }(i), and remaining terms are constraints.

7. The method of claim 6, wherein the pruning ratio for the individual layer r(i,g) is used to adjust a dimension of a decomposed tensor matrix that represents at least some of the updated model.

8. The method of claim 7, wherein the decomposed tensor matrix receives input that corresponds to the adjusted dimension.

9. The method of claim 7, wherein the decomposed tensor matrix outputs information corresponding to the adjusted dimension.

10. The method of claim 1, the method comprising:
employing knowledge distillation to train the model for the target hardware for classification tasks.

11. A computer readable medium comprising computer executable instructions for reducing machine learning models for target hardware, the instructions for:
providing a model, a set of training data, and a training threshold;
determining a search space for reducing the model with a pruning function and a pruning factor, wherein the pruning function increases compression along a depth of the model, and the compression increases are based on the pruning factor, by:
bounding the pruning function with two or more constraints;
determining, based on the two or more constraints, boundaries for the pruning factor, the determined boundaries defining at least in part the search space;
training the model to learn a reduced model by iteratively:
updating model parameters based on the pruning function and the pruning factor and within the search space;
evaluating the updated model based on the set of training data and the training threshold; and
providing the reduced model to a target hardware.

12. The computer readable medium of claim 11, wherein the instructions are for determining a granularity of the search spaced based on a number of searching steps.

13. The computer readable medium of claim 12, wherein the granularity |G| is defined as:
S=log 2(|G|).
where ‘s’ is the number of search steps.

14. The computer readable medium of claim 11, wherein the pruning function is a linear or exponential function.

15. The computer readable medium of claim 11, wherein a pruning ratio for an individual layer r(i,g) of the updated model is defined by:
r(i,g)=max(min(g·r\hat{ }(i),r max),r min)
wherein the pruning factor is g, the pruning function outputs r\hat{ }(i), and remaining terms are constraints.

16. The computer readable medium of claim 15, wherein the pruning ratio for the individual layer r(i,g) is used to adjust a dimension of a decomposed tensor matrix that represents at least some of the updated model.

17. The computer readable medium of claim 16, wherein the decomposed tensor matrix receives input that corresponds to the adjusted dimension.

18. The computer readable medium of claim 16, wherein the decomposed tensor matrix outputs information corresponding to the adjusted dimension.

19. The computer readable medium of claim 11, wherein the instructions are for employing knowledge distillation to train the model for the target hardware for classification tasks.

20. A device comprising a processor and memory, the memory comprising computer executable instructions for reducing machine learning models for target hardware, the instructions causing the processor to:
provide a model, a set of training data, and a training threshold;
determine a search space for reducing the model with a pruning function and a pruning factor, wherein the pruning function increases compression along a depth of the model, and the compression increases are based on the pruning factor, by:
bounding the pruning function with two or more constraints;
determining, based on the two or more constraints, boundaries for the pruning factor, the determined boundaries defining at least in part the search space;
train the model to learn a reduced model by iteratively:
updating model parameters based on the pruning function and the pruning factor and within the search space;
evaluating the updated model based on the set of training data and the training threshold; and
provide the reduced model to a target hardware.
